(19) United States
(12) Patent Application Publication
(10) Pub. No.: US 2015/0024891 A1
(43) Pub. Date: Jan. 22, 2015

(54) SUSPENSION ELEMENT FOR AN ELEVATOR SYSTEM

(71) Applicant: Inventio AG, Hergiswil (CH)

(72) Inventors: Anke Allwardt, Beckenried (CH); Adrian Attinger, Merlischachen (CH); Daniel Fischer, Villarsel-sur-Marly (CH); Ernst Ach, Ebikon (CH); Phillipe Henneau, Zurich (CH); Andre' Kreiser, Bietigheim-Bissingen (DE); David Risch, Herrliberg (CH); Urs Baumgartner, Merenschwand (CH); Hans Blochle, Hergiswil (CH); Joseph Muff, Hildisrieden (CH); Nicolas Gremaud, Wadenswil (CH); Steffen Grundmann, Bonstetten (CH); Karl Weinberger, Immensee (CH); Hans Kocher, Udlingenswil (CH); Guntram Begle, Kussnacht a/Rigi (CH); Heinrich Kuttel, Weggis (CH)

(21) Appl. No.: 14/511,443

(22) Filed: Oct. 10, 2014

Related U.S. Application Data
(63) Continuation of application No. 12/450,133, filed on Feb. 11, 2010.

(30) Foreign Application Priority Data
Mar. 12, 2007 (EP) 07103969.7
Mar. 28, 2007 (EP) 07105131.2
May 3, 2007 (EP) 07107468.6
Jun. 4, 2007 (EP) 07109521.0
Jun. 20, 2007 (EP) 07110653.8
Jul. 17, 2007 (EP) 07112641.1
Aug. 17, 2007 (EP) 07114522.1
Oct. 17, 2007 (EP) 07118710.8
Nov. 7, 2007 (EP) 07120211.3

(51) Int. Cl. B66B 7/06

(52) U.S. Cl. CPC B66B 7/062
USPC 474/204

(57) ABSTRACT

An elevator system includes a car or platform to transport passengers and/or goods as well as a counterweight, which are arranged as traversable or movable along a travel path, and which are coupled and/or with a drive by a suspension element interrelating their motion. The suspension element is guided and/or driven by a traction sheave and/or a drive shaft and/or a deflecting pulley. The suspension element is a sheathed and/or belt-type, with a first layer made of a first plasticizable and/or elastomeric material and a second layer with a connection plane formed between the first and second layers. At least one tension member—rope-type, tissue-type, or comprising a multitude of partial elements—is embedded in an area of the connection plane, a majority of a surface of said at least one tension member directly contacting said first layer. A manufacturing procedure for one of the suspension elements is provided.

### CROSS-REFERENCE TO RELATED APPLICATIONS

This application is a continuation of the co-pending U.S. patent application Ser. No. 12/450,133 filed Feb. 11, 2010.

### FIELD OF THE INVENTION

The present invention relates to an elevator system, an elevator system with a suspension element or force transfer arrangement, a suspension element or force transfer arrangement for an elevator system, a belt-type suspension element, as well as a procedure for manufacturing a suspension element, a procedure for manufacturing a belt-type suspension element for an elevator system, a respective device for manufacturing a belt-type suspension element.

### BACKGROUND OF THE INVENTION

An elevator system usually comprises at least one elevator car or platform to transport passengers and/or goods, a drive system with at least one hoisting machine to move the at least one elevator car or platform along a track, and at least one suspension element to carry the at least one elevator car or platform and to transfer the forces from the at least one hoisting machine to the at least one elevator car or platform. As suspension elements for mechanical drives, today, rope-type non-sheathed suspension elements (wire ropes, synthetic fibre ropes, etc.), chain-type suspension elements, and in particular also belt-type and/or sheathed suspension elements (and furthermore especially suspension belts or sheathed ropes) can be conceived.

Known belt-type suspension elements or force transfer arrangements include, among others, two-layer suspension belts, comprising of a first belt layer and a second belt layer connected to the first one. In them, usually several tension members are embedded in the moulded body of the suspension belt, in particular rope-type tension members. In known manufacturing procedures, two subsequent manufacturing stations produce first a partial belt constituting the first belt layer and then a finished suspension belt with a second belt layer moulded to the first belt layer. In the first manufacturing station, several rope-type tension members are fed simultaneously and are embedded by half into the first belt layer. First and second belt layer of the suspension belt are each produced by means of an extrusion procedure.

### BRIEF SUMMARY OF THE INVENTION

According to one aspect of the invention, an elevator system is conceived with a car and a counterweight arranged as traversable or movable along a track of motion. Preferably, an elevator system with a sheathed and/or belt suspension element comprising a first layer of the suspension element made of a first plasticizable and/or elastomeric material and having a first exterior surface, and at least one tension member embedded in said first layer of the suspension element, wherein said tension member is formed as a rope, a fabric, or a plurality of sub-elements is conceived. Besides, as to the solution of concrete design problems, EN 81-1: 1998, including CORRIGENDUM 09.99 is referred to.

According to one aspect of the invention, a belt-type suspension element for an elevator system is conceived. Advantageous further formations and embodiments of this invention are the subject of the description, and the figures. A belt-type suspension element according to invention (below often simply called “suspension belt”, “belt”, or “traction element”) for an elevator system preferably comprises a first belt layer of a first plasticizable material, with a first exterior surface and a surface constituting a connection plane. Furthermore, the suspension element preferably comprises at least one tension member—rope-type, tissue-type, and/or comprising of a multitude of partial elements—that is embedded in the first belt layer.

The tension member partly protrudes from a connection plane of the first belt layer to a second belt layer. Furthermore, a second belt layer is conceived, made of a (second) plasticizable material that is moulded to the first belt layer and the protruding sections of the at least one tension member at the connection plane, and constitutes a second exterior surface of the suspension belt.

In one embodiment of the invention, the surface of the at least one tension member is covered by at least 80%, preferably by at least 95%, with the first plasticizable material, and the clear spaces within the at least one tension member are, at least partly, filled with the first plasticizable material.

The first belt layer and the second belt layer of the suspension belt can optionally be made of the same material, the same material with different properties, or of different materials.

In one embodiment of the invention, the first exterior surface of the first belt layer is embodied with at least one rib extending longitudinally along the suspension element, preferably shaped as a V-rib, having a flank angle of between 60° and 120°, and/or being embodied with a flattened top.

In another embodiment of the invention, the second exterior surface of the second belt layer is embodied with at least one rib extending longitudinally along the suspension element, preferably shaped as a V-rib, having a flank angle of between 60° and 100°, and/or being embodied with a flattened top.

In still another embodiment of the invention, the ratio of total height of the suspension belt to its total width is greater than 1. Alternatively, however, this ratio can also amount to about 1 or be less than 1.

Therein preferably, one belt layer is made having a first exterior surface and a surface constituting a connection plane, with the at least one tension member partly protruding from the connection plane and the protruding section of the at least one tension member being covered at least partly by the first plasticizable material. The second belt layer is preferably made of a second plasticizable material, moulded to the connection plane of the first belt layer and to the protruding sections of the at least one tension member in such a manner that a suspension element is produced with the first exterior surface at the side of the first belt layer and a second exterior surface at the side of the second belt layer.

In this procedure, the tension members are embedded as completely as possible into the first plasticizable material of the first belt layer, so that the second plasticizable material for the second belt layer does not get in touch with the tension members. The protruding of the tension members from the connection plane between the two belt layers increases the size of the connection surface produced in the embedding step, so that a good connection between first and second belt layer can be achieved.

In one embodiment of the invention, the surface of the at least one tension member is covered, in the embedding step, by at least 80%, with the first plasticizable material. Preferably, here also the clear spaces within the at least one tension member are filled in the embedding step, at least partly, with the first plasticizable material.

For the first belt layer and the second belt layer, optionally the same material, the same material with different properties, or different materials can be used. In a further embodiment of the invention, the surface constituting the connection plane of the partial belt is given, at least partly, a surface structure before the step of moulding the second belt layer to it, whereby the surface is enlarged, thus creating a better connection with the second belt layer to be moulded to it later. Here, the surface structure at the connection surface is preferably being shaped during the embedding step. In a modified embodiment example, at least one layer is produced of an at least slightly vulcanizable material.

In a further embodiment of the invention, the first exterior surface and/or the second exterior surface are embodied with at least one rib extending longitudinally along the suspension element. The shaping of the ribs, too, preferably takes place during the embedding step or the moulding step. In another embodiment of the invention, the embedding step is executed as an extrusion procedure of the first plasticizable material, and the moulding step is executed as an extrusion procedure of the second plasticizable material.

In another embodiment of the invention, the first belt layer and the second belt layer are produced with the same or with different procedural parameters (e.g. temperature, pressure, rotation speed of the moulding wheel, etc.), which are optimally fitted to the first or second plasticizable material, respectively. In another embodiment of the invention, the at least one tension member is placed under pre-tension during the embedding step. For a better linking of the tension members with the first belt layer, preferably the at least one tension member is heated during the embedding step, and for a better linking of the first and the second belt layer, preferably the connection surface of the partial belt is heated during the moulding step.

The invention includes a sheathed and/or belt suspension element for an elevator system, comprising: a first layer of the suspension element made of a first plasticizable and/or elastomeric material and having a first exterior surface; a second layer of the suspension element, said first and second layers each being formed of one of polyurethane (PU), polyamide (PA), polyethylene terephthalat (PET), polypropylene (PP), polybutylene terephthalat (PBT), polyethylene (PE), polychloroprene (PCP), polyethersulphone (PES), polyphenylsulfide (PPS), polytetrafluoroethylene (PTFE), polyvinyl chloride (PVC), and ethylene propylene diene monomer rubber (EPDM) materials; a connection plane formed between the first and second layers; and at least one tension member embedded in an area of the connection plane, a majority of a surface of said at least one tension member directly contacting said first layer, wherein said tension member is formed as a rope, a fabric, or a plurality of sub-elements.

The invention includes a belt suspension element for an elevator system, comprising: a base body having a first traction surface arranged opposite a second traction surface, wherein said first traction surface directly engages with a first pulley or sheave and said second traction surface directly engages with a second pulley or sheave, said base body being formed of a plasticizable and/or elastomeric material; and at least one force transmission element formed as a rope, a fabric, or a plurality of sub-elements, wherein said at least one force transmission element is attached to said base body in a form-locking manner whereby said base body at least partially encloses said at least one force transmission element, a majority of a surface of said at least force transmission element directly contacting said base body, and wherein said base body has at least one subdivided layer, which layer is subdivided into individual spaced apart sections in parallel to a longitudinal extension of said at least one force transmission element.

### BRIEF DESCRIPTION OF THE SEVERAL VIEWS OF THE DRAWINGS

The above-mentioned as well as further features and advantages of the invention become better understandable through the following descriptions of preferred, non-restricting embodiment examples referring to the annexed drawings. The figures schematically show the following:

FIG. 1 is a depiction of the structure of an elevator system according to invention.

FIGS. 1aQ, 1bQ and 1cQ show different variants of suspension elements according to invention schematically represented, each in cross-sectional view.

FIGS. 1aS, 1bS and 1cS show different variants of a suspension belt for the elevator system having ribs and grooves in one or both sides or surfaces that engage a traction sheave and/or pulley.

FIGS. 2A, 2B are depictions of the structure of an elevator system according to invention with a traction drive, with an elevator car in a lower end position or in an upper end position in an elevator well.

FIG. 3 is a schematic perspective view of a basic structure of a belt-type suspension element according to the present invention.

FIGS. 4A and 4B illustrate a first manufacturing station used in a two-step manufacturing procedure for the suspension belt.

FIG. 5 illustrates the embedding process for the rope-type tension members into the suspension element.

FIG. 6 shows sections of the suspension element connection plane between the tension members embodied with a surface structure.

FIG. 6S shows a suspension element in cross section having different thickness belt layers.

FIGS. 7A and 7B illustrate a second manufacturing station used in the two-step manufacturing procedure for the suspension belt.

FIG. 7S shows a suspension element in cross section having a rounded belt layer.

FIG. 8 is a sectional view of another embodiment example of the suspension element according to invention, manufactured according to a procedure of the invention.

FIG. 9 is a sectional view of a belt-type suspension element according to another embodiment example of the invention, manufactured according to a procedure of the invention.

FIG. 10 is a sectional view of another belt-type suspension element according to another embodiment example of the invention, manufactured according to a procedure of the invention.

FIGS. 11A and 11B are schematic sectional views of two variants of a belt-type suspension element manufactured in a procedure according to invention.

### DETAILED DESCRIPTION OF THE INVENTION

The co-pending patent application Ser. No. 12/450,133 filed Feb. 11, 2010 is incorporated herein by reference. The reference characters and view numbers used herein correspond to the same reference characters and view numbers in the co-pending patent application.

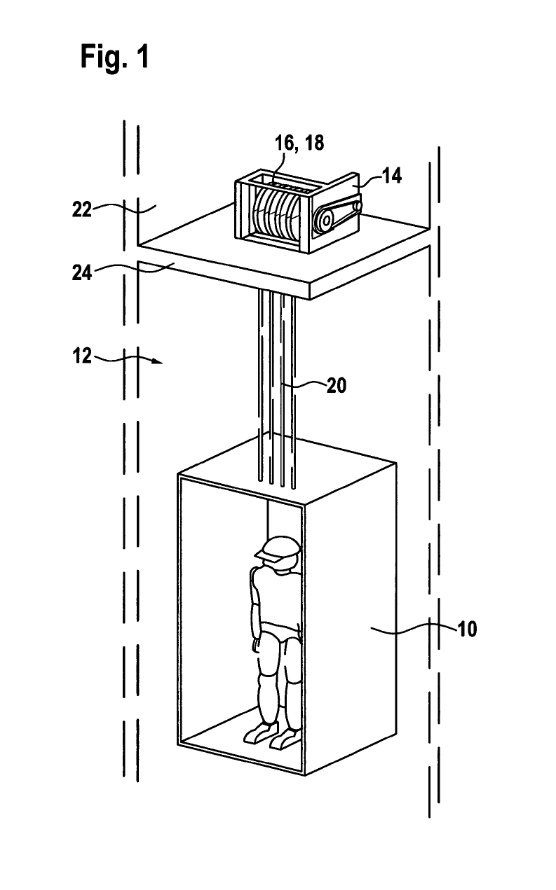

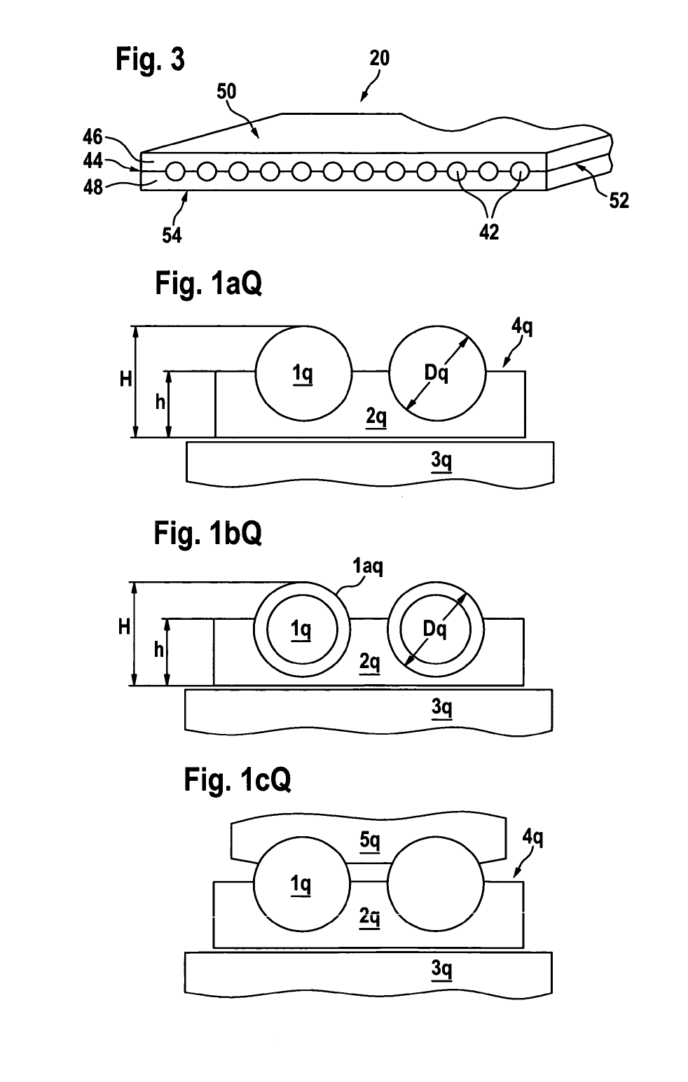

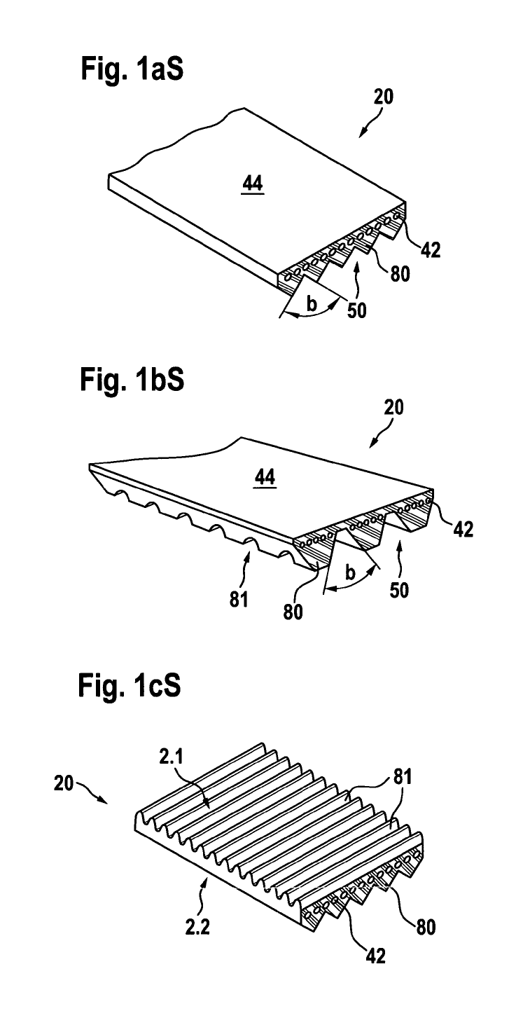

At first, the structure of an elevator system with drum drive will be described in more detail, referring to FIG. 1. The elevator system comprises an elevator car 10, movable upwards and downwards in an elevator well 12. In this movement, the elevator car 10 is guided along vertical guide rails (not depicted), for instance located at the walls of the elevator well 12. For moving the elevator car 10, a hoisting machine 14 is conceived, which, in particular, comprises a drum 18 driven by a motor 16 (motor and drum are preferably constructed as an integral unit), and a control (not depicted).

There is at least one suspension element 20 to carry the elevator car 10 and to transfer the forces from the hoisting machine 14 to the elevator car 10. In general, there are several suspension elements 20, running in parallel, as is indicated in FIG. 1. The one end of the suspension element(s) 20 is fixed above the elevator car 10, and the other end of the suspension element(s) 20 is coiled on the drum 18 of the hoisting machine 14. The movement of the elevator car 10 is produced just by coiling/uncoiling the suspension element(s) 20 on or off the drum 18 of the hoisting machine 14, through turning that drum 18. Suspension elements are preferably conceived as round, rope-type, sheathed and non-sheathed suspension elements. In a modified embodiment example, however, also non-round sheathed and non-sheathed suspension elements are conceived, the width of which is about the size of their height. Details regarding the employable suspension elements are found in other sections of this document, which are referred to in full.

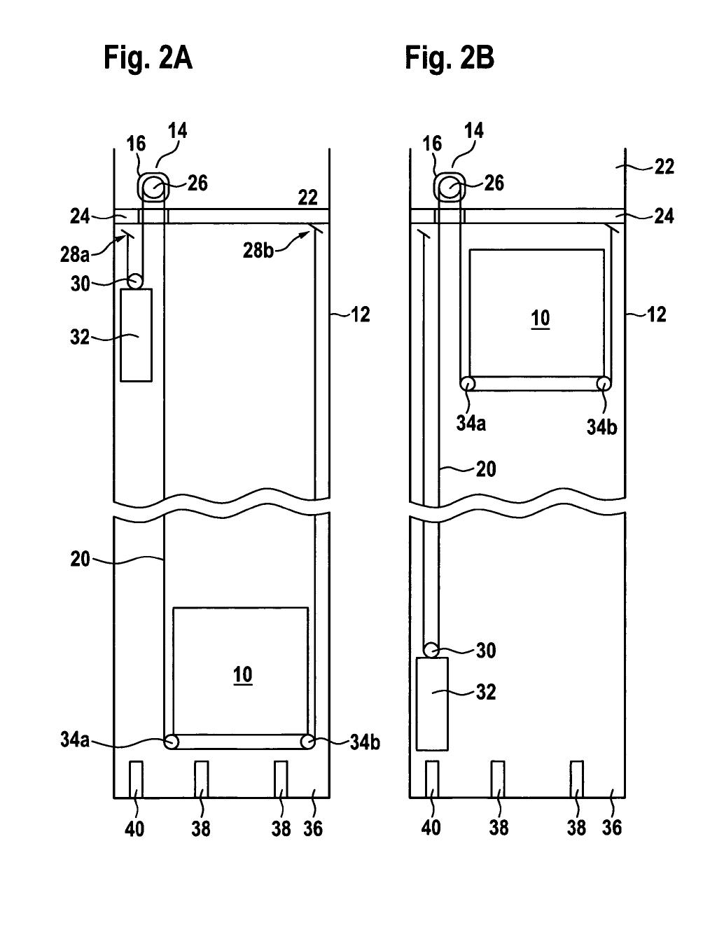

A possible structure of a drum drive according to invention has been exemplarily explained on the basis of FIG. 1. Numerous further variants are conceivable. Other than with the traction drive still to be explained below on the basis of FIGS. 2A and 2B, no counterweight is conceived in the embodiment of FIG. 1. Yet a counterweight is conceivable with a drum drive. The counterweight is then coupled, via a second suspension element, with the drum 18 of the hoisting machine 14, so as to reduce the required driving forces provided by the motor 16. In the well pit of elevator well 12, preferably buffers for elevator car 10 are arranged. While in FIG. 1, the suspension elements 20 are fixed at the upper side of elevator car 10, an under-wrapping of elevator car 10 by the suspension elements 20 is conceivable, too.

In FIG. 1, the hoisting machine 14 is arranged in a machine room 22 above the elevator well 12, with the machine room 22 being separated from the elevator well 12 by a well ceiling 24, a transverse girder, a web, or the like. Yet also elevator systems without a machine room are possible, and the hoisting machine 14 can alternatively also be arranged beside elevator well 12. For instance, the hoisting machine 14 can also be attached on the guide rails for the elevator car 10 and/or the counterweight.

A(nother) possible structure of an elevator system according to invention with a traction drive is explained in more detail below, with reference to FIGS. 2A and 2B. There, equal or corresponding components are assigned the same reference numbers as with respect to the drum drive depicted in FIG. 1.

The elevator system comprises an elevator car 10, movable upwards and downwards in an elevator well 12. In its movement, the elevator car 10 is guided along vertical guide rails (not depicted), for instance located at the walls of elevator well 12. For moving the elevator car 10, a hoisting machine 14 is conceived, which, in particular, comprises a traction sheave/drive shaft 26 driven by a motor 16, and a control (not depicted). For carrying elevator car 10 and for transferring the forces from hoisting machine 14 to elevator car 10, a force transfer arrangement is conceived with at least one suspension element 20, the two free ends of which are fixed in or at the elevator well 12, at fixing points 28a and 28b. According to invention, for instance the suspension element end connection devices described elsewhere in this document can be employed.

From the first fixing point 28a (on the left in FIGS. 2A and 2B), the suspension element 20 at first runs downward along elevator well 12, then wraps a counterweight idler pulley 30, on which a counterweight 32 is suspended, and then runs back upwards towards the traction sheave 26 of the hoisting machine 14. After wrapping traction sheave 26, the suspension element 20 extends downward again and wraps the elevator car 10 which, to this end, comprises two car idler pulleys 34a and 34b at its bottom side, which are wrapped by the suspension element 20 by about 90° each. Subsequently, the suspension element 20 runs along elevator well 12 upwards again, to the second fixing point 28b.

The traction sheave 26 transfers the forces generated by motor 16 to the suspension element 20, which is coupled both with the elevator car 10 and with the counterweight 32. With a rotation of the traction sheave 26, the elevator car 10 and the counterweight 32 move upwards and downwards in opposite directions in elevator well 12, by means of suspension element 20. FIG. 2A shows the elevator car 10 in its lower operation end position (i.e., the counterweight 32 in its upper position), and FIG. 2B shows the elevator car 10 in its upper operation end position (i.e., the counterweight 32 in its lower position).

A crucial advantage of the traction drive is the fact that, due to the counterweight 32 conceived, relatively low motor moments of the hoisting machine 14 are needed. Although not depicted, the counterweight 32, too, is usually guided along vertical guide rails, for instance at the walls of the elevator well 12. In the well pit 36 of the elevator well 12, usually buffers 38 for the elevator car 10 and buffers 40 for the counterweight 32 are arranged. The structure of the traction drive has been exemplarily explained above, on the basis of FIGS. 2A and 2B, but numerous variants are conceivable. While in FIGS. 2A and 2B, the elevator car 10 and the counterweight 32 are both arranged in the elevator well 12, it is possible, too, to conceive an own counterweight well for counterweight 32, which is separated from the elevator well 12 by a separation wall or the like.

Furthermore, in FIGS. 2A and 2B, two car idler pulleys 34a and 34b are conceived underneath the car floor of elevator car 10, at both sides, so that the elevator car 10 is under-wrapped by the suspension element 20. Alternatively, it is also possible to position the two car idler pulleys 34a and 34b at the upper side of elevator car 10 (in analogy to the counterweight idler pulley 30 in FIGS. 2A and 2B). Analogously, the counterweight idler pulley 30 can also be positioned underneath the counterweight 32 instead of at its upper side, so that the suspension element 20 under-wraps the counterweight 32. Besides, the numbers of the idler pulleys are, of course, not restricted to the one counterweight idler pulley 30 and the two car idler pulleys 34a and 34b.

While in FIGS. 2A and 2B, respectively, only one suspension element 20 is depicted, it is usual, in particular for safety reasons, to conceive several suspension elements 20 of the same kind which run in parallel along the above-described courses. In FIGS. 2A and 2B, a 1:2-suspension of elevator car 10 by the suspension element 20 is illustrated. But other arrangements are possible as well, like, for instance, a 1:4-suspension, a 1:8-suspension, etc., in which the area of suspension element 20 that is driven by hoisting machine 14 moves four times, eight times, etc. faster than elevator car 10. An elevator system with a 1:4-suspension is, for instance, described in detail in WO 2006/005215 A2 of the applicant, which document is therefore referred to in full with respect to structure and functioning of a 1:4-suspension.

In FIGS. 2A and 2B, the hoisting machine 14 is arranged in a machine room 22 above the elevator well 12, with the machine room 22 being separated from the elevator well 12 by a well ceiling 24, a transverse girder, a web, or the like. But also elevator systems without a machine room are known, and the hoisting machine 14 can alternatively also be arranged underneath the elevator well 12 or beside it. For instance, the hoisting machine 14 can also be fixed on the guide rails for elevator car 10 and/or counterweight 32.

The fixing points 28a, 28b for the free ends of suspension element 20 are not necessarily positioned in the upper area of elevator well 12. They can equally be arranged in the lower area of elevator well 12 or at arbitrary intermediate levels, with a correspondingly adapted course of the suspension element 20. Nor do the two fixing points 28a, 28b have to be arranged at the same (vertical) level. They can equally be conceived at different vertical level positions. Optionally, the free ends of suspension element 20 can also be fixed directly at counterweight 32 and at elevator car 10, in particular to realize a 1:1-suspension.

In elevator systems with higher operation speeds, generally so-called sub-suspension elements are used, too, apart from the above-described suspension elements 20. They are tensioned via a deflecting pulley located in well pit 36, between car floor and lower side of the counterweight 32. In that way, they are to balance the weights of the upper suspension elements 20 and prevent a “rebound” of elevator car 10 or counterweight 32 when counterweight 32 or elevator car 10 touch down or are clamped.

As suspension elements for mechanical drives, today rope-type suspension elements (wire ropes, sheathed ropes), chain-type suspension elements, and quite recently in increasing numbers also belt-type and/or sheathed non-round suspension elements (suspension belts) are found in elevator systems. The present invention relates, among other things, to the improvement of belt-type suspension elements.

Structure, functioning, and manufacturing procedures for a sheathed, belt-type or non-round suspension element for an elevator system according to the present invention are described below, with reference to FIGS. 3-11. FIG. 3 schematically shows the basic structure of a belt-type suspension element 20 for an elevator system. In FIG. 3, several tension members, in particular several rope-type tension members 42, can be seen, embedded in a belt-type moulded body (belt body) 44. As rope-type tension members 42, in the context of the present invention particularly ropes, strands, cords, or braidings of metal wires, steel, synthetic fibres, mineral fibres, glass fibres, carbon fibres, and/or ceramic fibres can be used. The rope-type tension members 42 can be made of one or more single elements, or of singly or multiply stranded elements. Further variants and possibilities to dimension and design the tension members are described in more detail elsewhere in this document.

In one embodiment of the invention, each tension member 42 comprises a two-layered core strand with a core wire (e.g. of 0.19 mm diameter), and two wire layers laid around the latter (e.g. of 0.17 mm diameter), as well as one-layered outer strands arranged around the core strand, with a core wire (e.g. of 0.17 mm diameter), and a wire layer laid around the latter (e.g. of 0.155 mm diameter). Such a structure of a tension member, comprising for instance a core layer with 1+6+12 steel wires (i.e., 1 central wire surrounded by a first ring of 6 further wires—first wire layer—as well as a second ring of 12 further wires—second wire layer), and 8 outer strands with 1+6 steel wires, has proved in tests as advantageous regarding strength, manufacturability, and bendability. Here, the two wire layers of the core strand favourably have the same angle of lay, while the direction of lay of the one wire layer of the outer strands is opposite to that of the core strand, and the direction of lay of the outer strands around the core strand is opposite to that of their own wire layer. But of course, the present invention is not restricted to tension members 42 with this particular structure.

The use of rope-type tension members 42 (sometimes also called cords) with low diameters (or thickness) perpendicular to the longitudinal extension of the suspension element 20 allows the use of traction sheaves 26 and idler pulleys 30, 34a, 34b with small diameters. The diameter of the tension members 42 preferably ranges from 1 mm to 4 mm.

As is illustrated in FIG. 3, the belt body 44 of the suspension element 20 is constructed of a first belt layer 46 made of a first plasticizable material, and a second belt layer 48 made of a second plasticizable material, and has a first exterior surface 50 of the first belt layer 46, a connection plane 52 between first and second belt layer 46, 48, as well as a second exterior surface 54 of the second belt layer 48. The several tension members 42 are embedded in the two-layered belt body 44 in the area of the connection plane 52.

The first exterior surface 50 of the first belt layer 46 of belt body 44 for instance engages with the traction surface of traction sheave 26, while the second exterior surface 54 of the second belt layer 48 engages with the riding surfaces of the counterweight idler pulley 30 and the two car idler pulleys 34a, 34b. Of course, the suspension element 20 of the invention can also be employed in the opposite mode in an elevator system with traction drive as depicted in FIGS. 2A and 2B. I.e., the first exterior surface 50 of the first belt layer 46 of belt body 44 can equally engage with the traction surface of traction sheave 26, while the second exterior surface 54 of the second belt layer 48 engages with the riding surfaces of the counterweight idler pulley 30 and the two car idler pulleys 34a, 34b.

The first material for the first belt layer 46, and the second material for the second belt layer 48 are chosen, for instance, of an elastomer. For example, polyurethane (PU), polyamide (PA), polyethylene terephthalat (PET), polypropylene (PP), polybutylene terephthalat (PBT), polyethylene (PE), polychloroprene (CR), polyethersulphone (PES), polyphenylsulfide (PPS), polytetrafluoroethylene (PTFE), polyvinyl chloride (PVC), ethylene propylene diene rubber (EPDM), and the like can be used for the belt layers 46, 48 to form the moulded body 44 of the suspension element, but the invention is not to be restricted to the mentioned materials. Furthermore, also special adhesion mediators can be added to the materials of the first and second belt layer 46, 48, so as to increase the strength of the connection between the belt layers 46, 48 and between the first belt layer 46 and the tension members 42. Insertion of further tissues, tissue fibres, or other filling materials is equally possible.

As is explained below in more detail, the first and the second belt layer are each formed in an extrusion procedure. Basically, also a vulcanizable rubber material can be employed here, in which case the definite vulcanization can take place only after the extrusion procedure, so that the material for the extrusion process is flowable.

According to invention, the same material with the same properties, the same material with different properties, or different materials can be used for the first belt layer 46 and the second belt layer 48. As properties of the material(s) for the moulded body 44, in particular hardness, flowability, compression, properties of connectability with the rope-type tension members 42, color, and the like are relevant here.

In particular embodiments of the invention, at least one of the belt layers 46, 48 can be formed of a transparent material, so as to facilitate a test of suspension element 20 for damages. Besides, the first and/or the second belt layer can be embodied in anti-static quality. In another embodiment, for instance the second belt layer can be embodied as luminescent, so as to make the rotation of the traction sheave or the drum recognizable or to produce certain optic effects.

The embedding of the rope-type tension members 42 into the first belt layer 46 effects a lubrication of their individual wires in their movement against each other during use in an elevator system. Besides, in that way the tension members 42 are additionally protected against corrosion and kept exactly in their desired positions.

To increase the contact pressure of the suspension element 20 onto a traction sheave 26, it is advantageous in view of an increase in the tractive capacity to embody the contact surfaces of the belt body 44 interacting with traction sheave 26, i.e. the first or the second exterior surface 50, 54, with so-called (V-)ribs (not depicted in FIG. 3). The said ribs extend as longish elevations in the direction of the longitudinal extension of the suspension element 20, and preferably engage with correspondingly shaped grooves on the riding surface of traction sheave 26. With their engaging with the grooves of traction sheave 26, the V-ribs at the same time provide a lateral guiding of suspension belt 20 on traction sheave 26.

Furthermore, the two exterior surfaces 50, 54 of the suspension element 20 of the invention may have, over their whole length or only in respective partial sections in which they contact with the traction sheave 26 and the various hitch and deflecting pulleys of the elevator system, a special surface quality that particularly affects the slide properties of the suspension belt 20. For instance, the exterior surface 50, 54, combing with the traction surface of traction sheave 26, can be equipped with a traction-reducing or traction-increasing coating, surface structure, or the like. Alternatively, the suspension belt 20 can also be sheathed with a tissue or the like on one or both exterior surfaces 50, 54, to influence the properties of the suspension belt surface.

Basically, it is possible to conceive several differently embodied suspension belts 20 of the described type, in different grouping, in the context of a force transfer arrangement in an elevator system.

In FIGS. 1aQ, 1bQ and 1cQ, further different variants of suspension elements according to invention are schematically represented, each in cross-sectional view. Besides, a respective interaction with a traction sheave and/or a guide pulley is outlined in the said figures. A suspension element has a (total) height H perpendicular to a traction surface 3q at which the suspension element interacts with a traction sheave or drive shaft. Equally acting functional elements are assigned equal reference signs.

The following elements, described below, are of particular relevance in FIGS. 1aQ-1cQ:
1q: tension member or rope of steel, aramid, etc., comprising several strands, with the strands being made of individual fibres or wires
1aq: separate sheathings of the individual ropes 1q (possibly transparent or multi-coloured or of different colors)
Dq: diameter of a tension member
2q: bed—one-layered or multi-layered—of elastomer, in particular of polyurethane (PU), which encloses the tension members or ropes in a circumferential area ranging from 60°±40° to 200°±40°, and in particular also amounting to 180°±40°, and to 200°±20°
3q: traction surface, with a cylindrical, or concave (possibly toothed, roughened, smooth), or also adapted profile, in particular with a profile corresponding to longitudinal grooves
4q: backside “open” or with protection layer, at backside and perhaps laterally, maybe with guiding section for guide pulleys
5q: guide pulley engaging at backside 4q, possibly contoured

FIG. 1aQ shows two ropes 1q enclosed on their front side facing traction surface 3q by a bed 2q in a circumferential area of about 200°±20°, backside 4q “open” or with protection layer, traction surface 3q cylindrical, or convex (possibly toothed, roughened, smooth). FIG. 1bQ is like FIG. 1aQ, but ropes 1q with a separate, possibly transparent sheathing 1aq, enclosed by a bed 2q in a circumferential area of about 180°±40°. FIG. 1cQ is like FIG. 1aQ, but the “open” backside 4q interacts with a guide pulley 5q.

According to FIGS. 1aQ, 1bQ, 1cQ, preferably a basically cylindrical traction surface with major or minor surface roughness and optionally with groove-type and/or tooth-type surface structures is conceived. Preferably, in many variants the cross-sectional shapes and/or contours of indentations and elevations side-of-traction-sheave are preferably basically identical over the whole traction sheave or drive shaft. There is hence an extended traction section, the grooves and elevations of which have basically the same distance to each other and on which, at an arbitrary site, several, in particular three or more, similar suspension elements may run side by side. Preferably, the distance between two suspension elements equals the width of a groove. The traction sheave section is hence embodied such that during operation of the elevator system a suspension element can basically adopt at least five, in particular at least seven or at least nine different operation positions on the traction section (essentially invariant in axial direction of the traction sheave/shaft), and the (possible) operation positions of the one suspension element are shifted against each other by the same distance from the respective neighbouring operation position.

The suspension elements according to invention (without reference sign) comprise several ropes 1q embodied as tension members which, in turn, are made of several strands (reference is here made to the details revealed elsewhere in this document). The strands are set up of a multitude of fibres or wires twisted with each other. The ropes are assigned a cross-sectional diameter Dq (with experts knowing that usual ropes have no exactly round cross-section). As materials, all materials revealed in this document in the context of tension members according to invention can be used, in particular high-strength steel or Aramid.

The (several) tension members 1q of a suspension element are each assigned a bed or moulded body 2q, made of an elastomeric and possibly plasticizable plastic. Here, several tension members are, at least by half their volume, embedded into a common bed 2q, so that they are at least half surrounded or enclosed by the plastic of the bed/moulded body. Preferably, about 180°-200° (±20°) of the circumferential contour of the essentially cylindrical tension members 1q is enclosed by the material of the bed/moulded body 2q. In particular, the height h of bed 2q is smaller than the height H of the suspension elements, preferably h<H*0.8.

According to FIGS. 1aQ, 1bQ, 1cQ, the moulded body 2q contacts with the correlated traction sheave in the area of the traction surface 3q over a certain surface, and is hence suitable and conceived to transfer traction forces onto the embedded tension members 1q. According to FIG. 1cQ, at least one guide pulley 5q is conceived, which engages with the suspension element at its backside and positions the suspension element in a form-locking manner between itself and the traction sheave. According to invention, the guide pulley engages with at least one (possibly sheathed) tension member 1q (and, to this end, has a rounded groove according to the diameter Dq of the tension member), and/or the guide pulley 5q grips at the moulded body 2q.

FIG. 1aS shows another, modified (flat) suspension belt 20 for the elevator system according to invention which has a moulded body formed in one piece. During operation, one side of the suspension belt 20 (a traction side 50) is facing a traction sheave 26. This side 50 is embodied with V-ribs 80. The V-ribs 80 are oriented in longitudinal direction of belt 20. The moulded body 44 of the V-ribbed belt 20 is preferably made of polyurethane, and harbours tension members 42 oriented in longitudinal direction of the flat belt 20. The tension members 42 give the V-ribbed belt 20 the required tensile strength and/or longitudinal stiffness. They can be made of metallic materials and/or non-metallic materials, like natural and/or synthetic/chemical fibers, and can be embodied as tissues, in particular as flat-spread tissues, and/or as rope-type tension members 42, as it is depicted here. Further possible variants regarding the choice of materials and shapes for the tension members and the sheathing are mentioned elsewhere in this document and are applicable in the present embodiment example.

With the choice of a V-ribbed belt 20 as suspension element for the elevator according to invention, a traction sheave 26 with a diameter of 70 mm-100 mm, preferably of 85 mm, can be used to transfer the required tractive force onto suspension element 20 while avoiding an inadmissibly high bending strain of suspension element 20. The mounting space for the drive can thus be designed as more narrow. With given tractive force, the torque to be provided at the drive shaft is correspondingly lower thanks to the smaller traction sheave diameter. The drive torque required from hoisting machine 14 can be further reduced with the help of a V-belt drive (not depicted). Since the diameters of electric motors are approximately proportional to the torque generated, the dimensions of hoisting machine 14 and hence the whole mounting space for the described drive arrangement can be kept minimal. Modified variants of hoisting machines to be used according to invention and conceived according to invention are mentioned and described in detail elsewhere in this document. In the present elevator system, they can be used with advantage.

In the embodiment according to FIG. 1aS, the ribs 80 are separated by grooves from each other, with both ribs and grooves having a triangular cross-section. The angle b between the flanks of a rib 80 or a groove affects the operation properties of the V-ribbed belt 20, and in particular its quiet running and its tractive capacity. Tests have shown that, within certain limits, the following holds: the greater angle b, the better the quiet running and the worse the tractive capacity. Taking the requirements regarding quiet running and tractive capacity into account, angle b should range between 80° and 100°. An optimal compromise between the contrasting requirements is achieved with V-ribbed belts the angle b of which amounts to about 90°.

In another embodiment, the flat-belt type suspension element 20 has at least two tension members 42 per rib, oriented in longitudinal direction of the suspension element, with the total cross-sectional surface of all tension members 42 amounting to 15%-30% of the cross-sectional surface of the suspension element, in particular to 20%, or to more than 25%.

Another possibility of embodying the V-ribbed belt 20 can be seen in FIG. 1bS. In this example, the ribs 80 separated from each other by grooves have a trapezoidal cross-section each. Besides, transverse grooves 81 are conceived apart from the V-ribs 80 on the side 50 facing the traction sheave, which intersect grooves and ribs 80. These transverse grooves 81 improve the bending flexibility of the V-ribbed belt 20, so that the latter can interact with traction sheaves 26 with particularly small diameters. The surfaces of a traction sheave 26 conceived for interaction with the V-rib-type, flat suspension elements 20 described here can be cylindrically even, and/or equipped with shaped grooves, and/or with grooves arranged in circumferential direction to receive the V-ribs 80. Further particularly preferred variants of traction sheaves are described elsewhere in this document and can be used in the present embodiment examples with advantage.

Besides, radial ribs in parallel to the axis of traction sheave 26 can be conceived to interact with a suspension element 20 according to FIG. 1bS, which—similar to a toothed belt with a toothed wheel—interact with the transverse grooves 81 of suspension belt 20, and counteract a sliding of belt 20 on traction sheave 26. The transverse grooves 81, here, preferably have a depth of 0.01 mm-0.5 mm, and no corresponding “teeth” on the part of the suspension belt have to be conceived.

FIG. 1cS shows another embodiment of a V-ribbed belt 20 with transverse grooves 81, as it is already known from FIG. 1bS, with the transverse grooves 81 in this embodiment example being arranged on the side 2.1 opposing the V-ribs 80. Such a V-ribbed belt can not only serve as a suspension element and drive element for the elevator car, but also to record the position of the elevator car. The transverse grooves 81 form a toothing at the deflection side 2.1 of belt 20, with teeth oriented transversely to its longitudinal direction that engage in a form-locking manner with a toothed wheel of a detector.

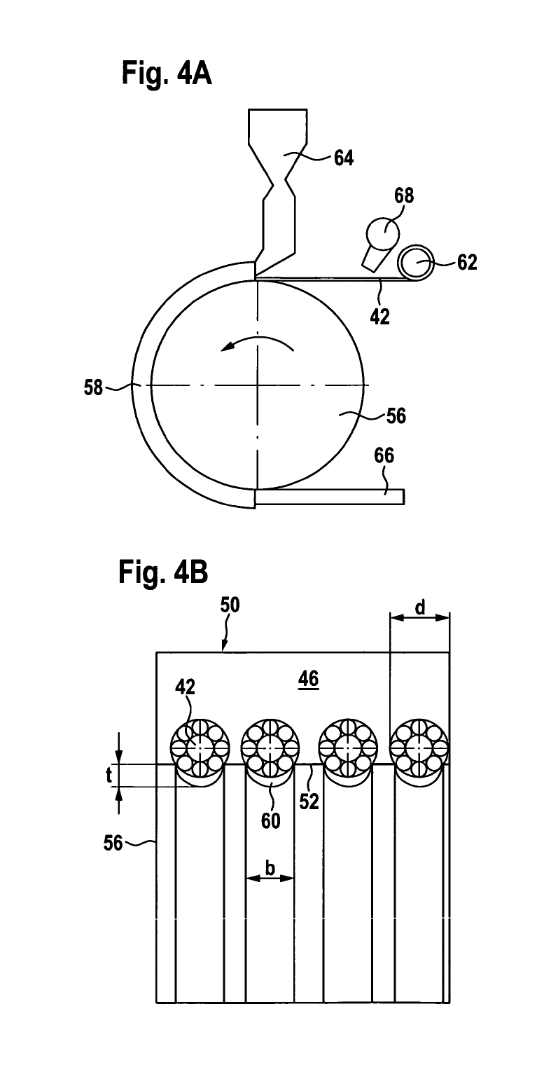

On the basis of FIGS. 4-7, a first manufacturing procedure of a suspension element according to invention in form of the suspension belt 20, as well as the corresponding device to manufacture the suspension belt, will now be explained in detail. Of course, further modified manufacturing procedures may be applied as well, in particular those that are also exemplarily described elsewhere in this document. At this point, it is to be made clear once again that the notion of “belt” is to be understood as referring to all sheathed suspension elements (independent of the cross-sectional shapes of their tension members and/or their sheathing).

The procedure to manufacture the suspension belt 20 with a first belt layer 46 and a second belt layer 48 and rope-type tension members 42 embedded in it is a two-step procedure. The first manufacturing station of this two-step manufacturing procedure is illustrated in FIG. 4A, and the second manufacturing station in FIG. 4B. It is to be taken into account that the first and the second manufacturing station are either organized as separate manufacturing stations, or are, within an integral manufacturing process, series-connected immediately after one another.

As depicted in FIG. 4A, the first manufacturing station for the belt-type suspension element 20 of the invention comprises a first rotating moulding wheel 56 and a first guide 58 wrapping a partial section of this first moulding wheel 56. This first guide 58 can, for instance, be formed of an endless moulding band, which is guided over several pulleys and, together with the exterior circumferential surface of the first moulding wheel 56, forms a mould cavity. Alternatively, the first guide to form the mould cavity can also comprise a stationary moulded body, which is equipped with a sliding element to allow a′relative movement between the stationary moulded body and the moulded body moving with moulding wheel 56.

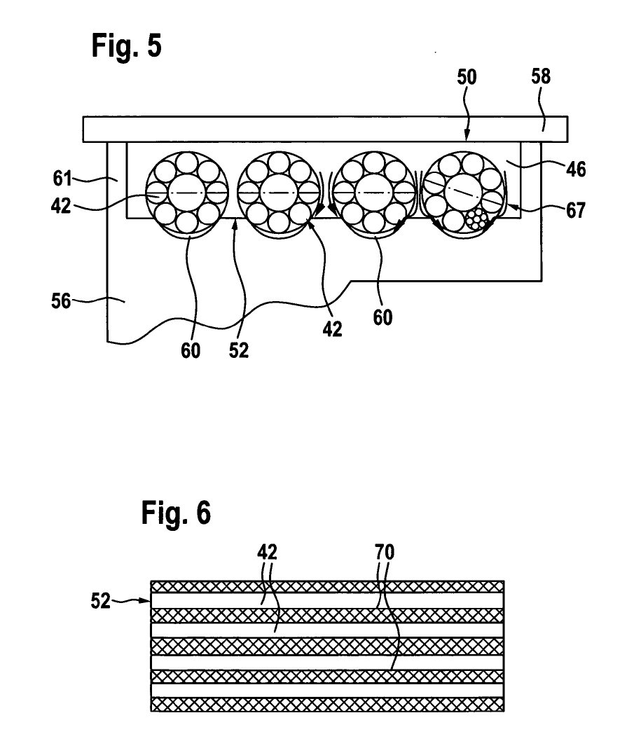

The exterior circumferential surface of the first moulding wheel 56 is embodied with several longitudinal grooves 60, which extend along the circumferential direction of the moulding wheel, as depicted in FIG. 4B. The width of the exterior circumferential surface of moulding wheel 56, preferably bordered by suitable lateral guide elements 61 (cf. FIG. 5) corresponds with the desired width of the suspension element 20, and the number of longitudinal grooves 60 in the exterior circumferential surface of the first moulding wheel 56 corresponds with the desired number of rope-type tension members 42 in the suspension element 20.

As is illustrated in FIG. 4B, the width b of the grooves 60 is chosen smaller than the diameter d of the tension members 42. For instance, width b of grooves 60 ranges from about 70% to 95% of diameter d of the tension members 42, more preferably from about 75% to 90%. Besides, the depth t of the longitudinal grooves 60 ranges from about 25% to 50%, preferably from about 30% to 40% of the diameter d of the tension members 42.

In the first manufacturing station of FIG. 4A, now the rope-type tension members 42 are fed from a stock reel 62 to the first moulding wheel 56, being guided in the longitudinal grooves 60 of the exterior circumferential surface of the first moulding wheel 56, and preferably being kept under pre-tension. Due to the above-described dimensioning of width b and depth t of the longitudinal grooves 60 in relation to diameter d of the tension members 42, the tension members 42 are only partly received in the longitudinal grooves 60, and between the tension members and the first moulding wheel 56, clear spaces form in the areas of the longitudinal grooves 60.

From a first extruder 64, a flowable stream of the first material is brought, basically without pressure, into the mould cavity formed between the first moulding wheel 56 and the first guide 58, with the at least one tension member 42 bearing on the exterior circumferential surface of the first moulding wheel 56 before the stream of the first material enters the mould cavity. The material stream out of the first extruder 64 is pressed by the first guide 58 against the tension members 42 and the first moulding wheel 56, thus getting its definite shape, and finally forms the partial belt 66 with the first belt layer 46 and the tension members 42 embedded in it. Here, the first exterior surface 50 of partial belt 66 or suspension element 20 is facing guide 58, and the surface of partial belt 66 forming the connection plane 52 is facing the first moulding wheel 56.

As illustrated in FIG. 5, in this embedding process the flowable first material also flows into the cavities within the rope-type tension members 42, and through these cavities as well as through the clear spaces between the tension members 42 and the first moulding wheel 56 formed through the twisting of the tension members 42 (cf. flow lines 67 indicated by arrows in FIG. 5) also into the clear spaces of the mould cavity formed between the tension members 42 and the respective grooves 60. In that way, the cavities within the rope-type tension members 42 are, at least partly, filled with the first material, which results in a very good connection between the tension members 42 and the first belt layer 46 comprising of the first material. Besides, the tension members 42 are embedded as completely as possible in the first belt layer 46, so that there is no direct contact between the embedded tension members 42 and the adjacent second belt layer 48.

The properties of the first plasticizable material (especially its flowability) and the procedural parameters of the first manufacturing station (especially temperature and pressure) are to be chosen here such that in the embedding step the first material can enter the cavities within the rope-type tension members 42 and the cavities between tension members 42 and first moulding wheel 56, as is explained above, on the basis of FIG. 5.

In the embodiment example represented in FIGS. 4-5, the at least one tension member 42 of the suspension belt 20 protrudes by about 5%-20% from the connection plane 52 of partial belt 66 after the first manufacturing step in the first manufacturing station. At the same time, more than 80%, preferably more than 90%, more preferably more than 95% of the surface of the at least one tension member 42 are covered with the first plasticizable material of the first belt layer 46.

To further improve the connection between the first plasticizable material for the first belt layer 46 and the tension members 42 to be embedded, it is of advantage to heat the tension members 42 during this embedding process. To this end, for instance upstream of the first extruder 64, a first heating device 68 is arranged to heat the tension members 42 to be fed to the first moulding wheel 56.

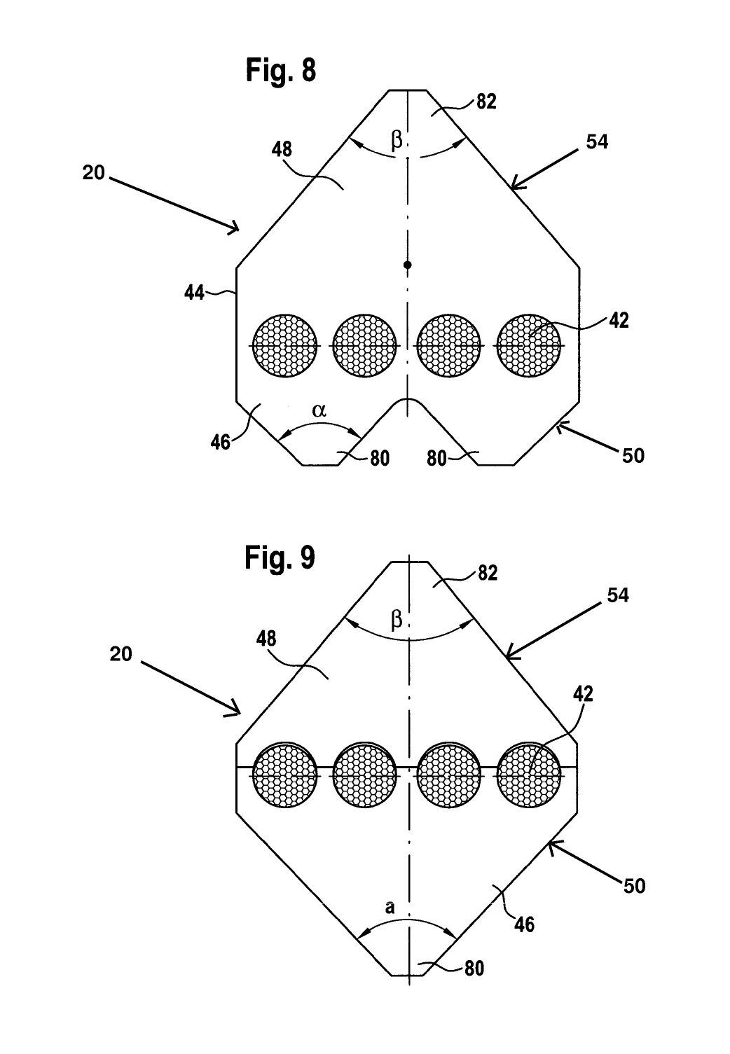

Though not depicted in FIGS. 4 and 5, the first guide 58 can be structured at its inner side facing the first moulding wheel 56, so as to give the first exterior surface 50 of partial belt 66 or of the finished suspension element 20 a profile. In particular, the first exterior surface 50 of suspension belt 20 can be equipped with V-ribs extending in longitudinal direction, as will be discussed later in the context of special embodiments of suspension element 20, on the basis of FIGS. 8-10. Alternatively or additionally, also further surface structures can be applied to this first exterior surface 50.

The profiling or structuring of the first exterior surface 50 of suspension belt 20 preferably occurs during the step of embedding the at least one tension member 42 into the first belt layer 46. Alternatively, however, the first exterior surface 50 of suspension belt 20 may also be mechanically or chemically treated in a separate further manufacturing step, after the second manufacturing step described below.

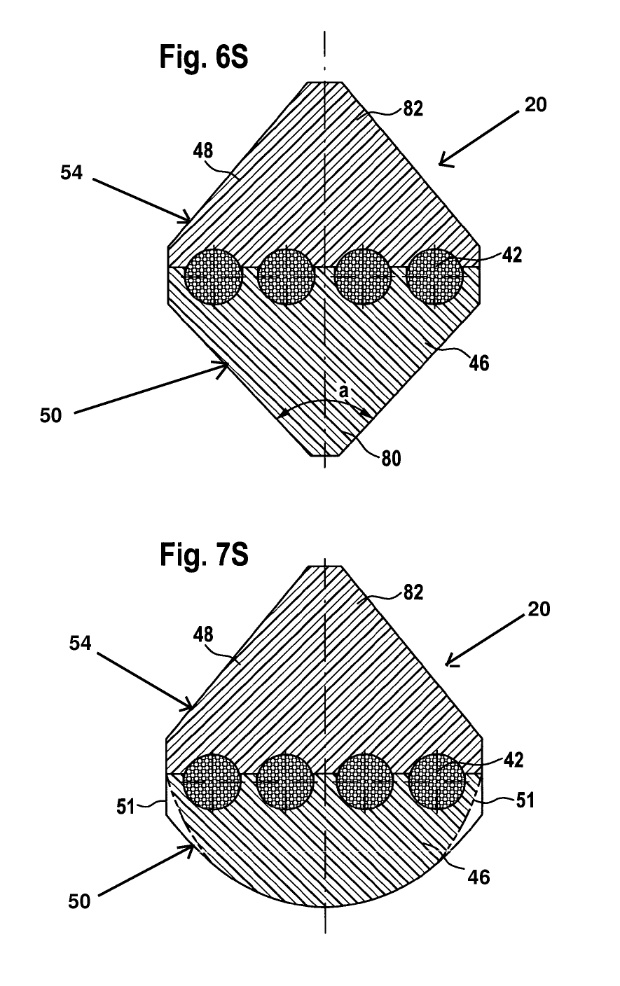

In an advantageous further embodiment of the invention, the first moulding wheel 56 or its exterior circumferential surface is embodied such that the connection plane 52 of partial belt 66 is equipped with a surface structure during the embedding step. As indicated in FIG. 6, preferably at least the sections of connection plane 52 between the tension members 42 are embodied with a surface structure 70, e.g. in the form of a raster-shaped or irregular roughening or grooving. Additionally, of course, also the areas of the tension members 42 in connection plane 52 can be embodied with a surface structure 70. Such a surface structure 70 enlarges the surface of connection plane 52, thus improving its later connection with the second belt layer 48.

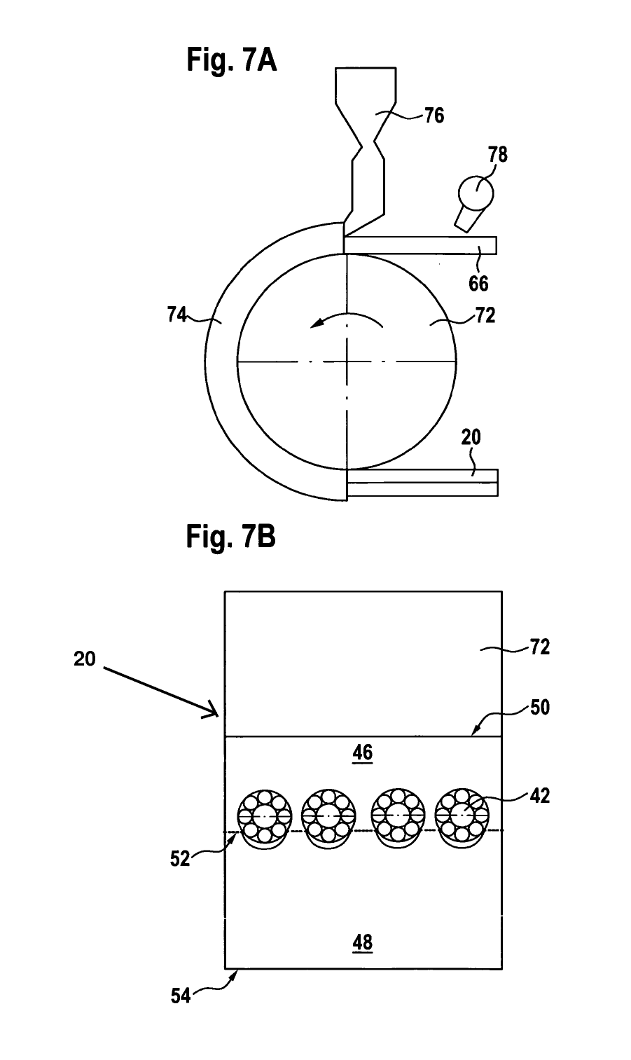

After the finishing of partial belt 66 in the first manufacturing station of FIGS. 4A and 4B, the suspension belt 20 is completed in a second manufacturing station, shown exemplarily in FIGS. 7A and 7B.

As depicted in FIG. 7A, the second manufacturing station for the belt-type suspension element 20 according to invention comprises, similarly to the first manufacturing station, a second moulding wheel 72 rotating in counter-clockwise sense, and a second guide 74 wrapping a partial section of this second moulding wheel 72. This second guide 74 can, for instance, again be formed by an endless moulding band that is guided over several pulleys, or alternatively also comprise a stationary moulded body equipped with a sliding element.

In contrast to the first manufacturing station of FIGS. 4A and 4B, the second moulding wheel 72 of the second manufacturing station is embodied with an exterior circumferential surface corresponding with the profile of the first exterior surface 50 of the first belt layer 46 or the partial belt 66. In the embodiment example shown in FIG. 7B, a flat exterior circumferential surface is conceived for the second moulding wheel if the first exterior surface 50 of suspension element 20 is to have no profile or maybe a flat surface structure. The width of the exterior circumferential surface of the second moulding wheel 72, preferably limited by suitable lateral guide elements (not depicted), equals the desired width of suspension element 20.

In the second manufacturing station of FIG. 7A, the partial belt 66 produced in the above-described first manufacturing station is fed to the second moulding wheel 72 in such a manner that the first exterior surface 50 of partial belt 66 is in contact with the exterior circumferential surface of the second moulding wheel 72. From a second extruder 76, a flowable stream of the second plasticizable material is brought, basically without pressure, into the mould cavity formed between the second moulding wheel 72 and the second guide 74. The material stream from the second extruder 76 is pressed against the connection plane of partial belt 66 by the second guide 74, in that way getting its definite shape, so that finally the complete suspension element 20 is formed, with first and second belt layer 46, 48 and the tension members 42 embedded between them. In this process, the second exterior surface 54 of suspension belt 20 faces the guide 74.

As illustrated in FIG. 7B, in this moulding process the flowable second material flows completely against the surface of partial belt 66 forming the connection plane 52. If this connection plane 52 has a surface structuring 70 as explained above, the connection between first and second belt layer 46, 48 is particularly good. Since the tension members 42 have been embedded as completely as possible into the first belt layer 46 in the first manufacturing station, the second belt layer 48 does hardly or not at all contact with the tension members 42.

To further improve the connection between the second plasticizable material for the second belt layer 48 and the partial belt 66 produced before, it is of advantage to heat the partial belt 66 during this moulding process. To this end, for instance upstream of the second extruder 76, a second heating device 78 is arranged to heat the partial belt 66 to be fed to the second moulding wheel 72 to a desired temperature.

Though not depicted in FIGS. 7A and 7B, the second guide 74 can be structured at its inner side facing the second moulding wheel 72, so as to give the second exterior surface 54 of the complete suspension belt 20 a profile. In particular, the second exterior surface 54 of suspension belt 20 can also be equipped with V-ribs running in longitudinal direction, as will be discussed later in the context of special embodiments of suspension element 20, on the basis of FIGS. 8-10. Alternatively or additionally, also further surface structures can be applied to this second exterior surface 54.

This profiling or structuring of the second exterior surface 54 of suspension belt 20 preferably occurs during the moulding step, in the second manufacturing station. Alternatively, however, the second exterior surface 54 of suspension belt 20 can also be treated mechanically or chemically after the second manufacturing step, in a separate further manufacturing step (possibly together with the first exterior surface 50).

Optionally the same materials, or different materials with the same or different properties can be used for first and second belt layer 46, 48. Due to the two-step manufacturing procedure, it is of advantage if the second material has a lower flow or melting temperature than the first material, so that the material stream fed by the second extruder 76 in the second manufacturing station may at most plasticize the surface of the first belt layer 46 at the connection plane 52 to reach a better connection between the two materials, but not the whole partial belt 66, thus ensuring that the shape of the tension members 42, enclosed by the first material as completely as possible, will be maintained.

In a preferred embodiment example, a softer material is conceived for the second belt layer 48 of suspension belt 20 than for the first belt layer 46 of suspension belt 20. For instance, the first material for the first belt layer 46 has a Shore hardness of about 85 at room temperature, while a second material with a Shore hardness of about 80 at room temperature is used for the second belt layer 48.

In the above-given embodiment example of the manufacturing procedure, it was described that the first and the second exterior surfaces 50, 54 can be embodied in the first or the second manufacturing stations optionally with even surfaces or with profiles. Furthermore, it is possible to equip one or both exterior surfaces 50, 54 with an additional coating, vapour-coating, flocking, or the like (not described), so as to selectively modify the surface properties, in particular the friction properties of the surfaces of the suspension element 20. This surface treatment can be optionally applied to the complete exterior surfaces 50, 54, or to only a part of the exterior surfaces, as for instance the flanks of respective V-ribs. For the second belt layer 48, which gets in contact with the deflecting pulleys, for instance a friction coefficient of μ≦0.3 is preferred.

Another procedure to manufacture a preferably one-layer belt-type suspension element for an elevator system comprises in particular the steps of the exact positioning of at least one rope-type tension element, and the embedding of the at least one rope-type tension element into a moulded body of a first plasticizable material, and the forming of the external contour of the moulded body.

In a preferred embodiment according to invention, the whole external contour or at least parts of the external contour of the moulded body are formed simultaneously with the embedding of the at least one tension member.

In another embodiment, the moulded body is manufactured with the tension members and a preliminary shape of the moulded body as a primary product. In a further step, at least a first part of the external contour is formed. This can be done by plastic forming, or by material-abrading procedures, in particular machining procedures like milling, grinding, or cutting.

In another preferred embodiment according to the present invention, a moulded body of a belt-type suspension element according to invention is produced of two belt layers. In another embodiment of the procedure to manufacture a belt-type suspension element, the procedure contains the steps of positioning at least one rope-type tension member, embedding the at least one rope-type tension member in a first belt layer of a first plasticizable material, and moulding a second belt layer of a second plasticizable material to the first belt layer in such a manner that a suspension element with embedded tension members is produced.

In a special embodiment of this procedure, the procedure contains the steps of positioning at least one rope-type tension member, embedding the at least one rope-type tension member in a first belt layer of a first plasticizable material such that a partial belt with a first exterior surface and a surface forming a connection plane is created, in which the at least one tension member partly protrudes from the connection plane of the partial belt, and the protruding section of the at least one tension member is at least partly covered by the first plasticizable material. Further steps are the moulding of a second belt layer of a second plasticizable material to the connection plane of the first partial belt and the protruding section of the at least one tension member such that a suspension element is created with a first exterior surface at the side of the first belt layer and a second exterior surface at the side of the second belt layer.

For the first belt layer and the second belt layer, optionally different materials, materials of the same material class, the same material with different properties, or the same material with the same properties can be used, and in particular an identical material for both layers.

In a special embodiment of the invention, a first partial belt is produced with a surface forming a connection plane. This surface of the first partial belt is at least partly enlarged before the step of moulding the second belt layer to it, by giving it a structure. This can be done by mechanically roughening the surface, by impressing on it or fusing in it a certain roughness or pattern, by etching it, or by using similar procedures to enlarge the physical surface. The enlarged surface allows a better chemical and/or physical connection with the second belt layer to be moulded to it later. In a particular cost-effective way, a surface structure of the connection plane is formed already during production of the first partial belt, by using a respective melting mould with pattern or great roughness in the area of the connection plane. Other options to improve the connection between a first and a second belt layer are impregnating or coating with an adhesive, heating or fusing the surface of the first belt layer immediately before the moulding step, and/or applying a plastic adhesive, possibly also a plastic-metal adhesive. The latter is favourable above all if the tension members are made of metal and are not completely embedded in one of the belt layers.

In another embodiment of the invention, the first exterior surface and/or the second exterior surface are embodied with at least one rib extending in longitudinal direction of the suspension element. The forming of the ribs, too, is preferably done during the embedding step or the moulding step.

In another embodiment of the invention, the step of embedding the tension members into a first belt layer is performed as a procedure of extruding the first plasticizable material, and the step of moulding the second belt layer is performed as an extruding of the second plasticizable material onto the first belt layer.

In another embodiment of the invention, the first belt layer and the second belt layer are produced with the same or different procedural parameters (e.g. temperature, pressure, rotation speed of the moulding wheel, etc.), which are adapted to the first or the second plasticizable material, respectively.

In a modified embodiment of the invention, the first partial belt and the second partial belt are produced as primary products with the same or different parameters, and of the same or of different material(s). The two primary products are then assembled to a suspension belt, by welding their respective (long) sides embodied as connection planes, and/or fusing them, and/or pasting them, and/or calendering them. Preferably before assembling the belt layers, the tension members are embedded into one or both belt layers, preferably already during production of the belt layer(s). Alternatively or complementarily, (one or more) tension members are positioned onto a surface of at least one of the two belt layers embodied as connection plane and are preferably fixed there. Subsequently, the belt layers are assembled. The fixing can be done by pasting, by attaching with mechanical means, like clamps etc., or by melting, or fusing, or pressing the tension members onto or into the connection plane of the respective belt layer.

In another embodiment of the invention, the at least one tension member is positioned under pre-tension during the embedding step.

To better connect a tension member with a first belt layer, preferably the at least one tension member is heated during the embedding step, and to better connect first and second belt layer, preferably the connection plane of the partial belt is heated during the moulding step, and/or the surface is enlarged by roughening or generating a pattern, or is impregnated with an adhesive.

In general, the known procedures of plastics engineering are used here, and are combined with each other according to material, need, and requirement profile. Evidently, the individual known procedural steps or procedures can be combined with one another. The known procedures of plastics engineering which are used here on their own or in combination, in succession or toothed with one another, are, for instance explained in “Oberbach et al., Saechtling Kunststoff Taschenbuch, 29th edition, Hanser, Munich 2004”, in chapter 4, in particular in sections 4.2.3 and 4.3.5, in particular in 4.2.5.4, 4.2.5.5, 4.2.5.9, and 4.2.5.10, as well as 4.2.6, 4.2.7, in particular in 4.2.7.1 and 4.2.7.2, in 4.2.9, 4.3.3, 4.4.1, 4.4.2, 4.4.3, 4.4.4, 4.4.5. According to invention, the procedures and procedural steps described in “Oberbach et al., Saechtling Kunststoff Taschenbuch” are drawn upon to produce belt-type suspension elements according to invention, and therefore the mentioned book is here referred to in full. Modifications and further developments of the basically known procedures are supplementarily described in this document. Both with known and with modified procedures, suspension elements for elevators can be produced simply and cost-effectively, and/or their quality can be improved.

According to another aspect of the invention, a manufacturing device for a belt-type suspension element for an elevator system is conceived. The suspension elements for elevator systems described in more detail elsewhere in this document are preferably produced by means of the manufacturing devices or facilities described below, using the procedures also described in this document.

In a special embodiment, the device to manufacture a belt-type suspension element for an elevator system has a first manufacturing station to form a first belt section or belt layer with a first exterior surface and a surface forming a connection plane, and a second manufacturing station to form a (complete) suspension element with the first exterior surface and a second exterior surface. The first manufacturing station has a first moulding wheel, a first guide wrapping a partial circumference of the first moulding wheel, a device to feed at least one (preferably rope-type) tension member to the first moulding wheel, and a first extruder to feed a first plasticizable material into a mould cavity formed between the first moulding wheel and the first guide. The second manufacturing station has a second moulding wheel, a second guide wrapping a partial circumference of the second moulding wheel, a device to feed the belt section/belt layer produced in the first manufacturing station to the second moulding wheel, and a second extruder to feed a second plasticizable material into a mould cavity formed between the second moulding wheel and the second guide. The exterior circumferential surface of the first moulding wheel of the first manufacturing station defines the form of the connection plane of the first belt layer produced in the first manufacturing station. According to invention, it has a longitudinal groove extending in the circumferential direction of the first moulding wheel, into which the at least one tension member is fed and positioned. The depth of the longitudinal groove is smaller here than the radius of the tension member, so that the at least one tension member is embedded only with a part of its diameter in the first belt section, and with the other part protrudes from the connection plane.

The depth of the longitudinal grooves of the exterior circumferential surface of the first moulding wheel preferably ranges from about 25%-50% of the diameter of the tension members, preferably from about 30%-49%.

In another embodiment of the invention, a first manufacturing station moreover has a device to feed a tension member under pre-tension to the first moulding wheel, and a first heating device to heat the tension member before its being fed to the first moulding wheel.

In another embodiment of the invention, a first guide of the first manufacturing station is equipped at its side facing the first moulding wheel with a cavity structure, so as to profile the first exterior surface of the partial belt or suspension belt (e.g. with V-ribs).

In another embodiment of the invention, a first moulding wheel is structured at its exterior circumferential surface, in the area between the longitudinal grooves, so as to give the partial belt surface constituting the connection plane a corresponding surface structure. The structure has a microscopic surface roughness greater than Rz=10, in particular greater than Rz=20, so that the surface is physically enlarged, thereby contributing to a better connection between first and second belt layer of the suspension belt. Alternatively or additionally, the structure has macroscopic grooves with a depth of more than 15 μm, in particular of more than 25 μm. Preferably, grooves are conceived that run towards each other at an acute angle and form a regular or irregular pattern. Furthermore alternatively or additionally, the structure has undercuts.

In another embodiment of the invention, the second manufacturing station has a (preferably second) heating device, to heat the first belt layer before its being fed to the second moulding wheel. The second guide of the second manufacturing station is, at its side facing the second moulding wheel, optionally equipped with a cavity structure able to give the second exterior surface of the suspension element a profile, e.g. in the form of ribs or teeth.

In a modified embodiment, in a work station subsequent to the second manufacturing station, a plastic forming of the suspension element is executed, in particular by using a forming machine.

In another embodiment, a manufacturing station is conceived, in which the surface of the suspension element undergoes a material-abrading machining to reach a desired surface quality and/or surface shape. In particular, the suspension element is finish-machined by cutting, grinding, or milling.

Referring to FIGS. 8-10, different preferred embodiments of a belt-type suspension element 20 will be described below that can be produced by means of the above-described manufacturing procedure of the invention. The said suspension elements can be combined arbitrarily to force transfer arrangements according to invention, to equip an elevator system or elevatoring gear according to invention.

In the first embodiment example of FIG. 8, the suspension belt 20 has a moulded body 44 formed of a first belt layer 46 and a second belt layer 48, in which a tension member arrangement with a total of four rope-type tension members 42 is arranged. The first exterior surface 50 of the first belt layer 46 is conceived for contacting with traction sheave 26. To this end, it has two traction ribs in the form of V-ribs 80, which engage with assigned grooves of traction sheave 26 and are laterally guided by the latter, so that the contact pressure and hence the tractive capacity of the drive increase.

The second exterior surface 54 of the second belt layer 48 is conceived for contacting with the car idler pulleys 34a, 34b, and to this end has a guide rib in the form of a V-rib 82, which engages with an assigned roller of the deflecting pulley 34a, 34b and is laterally guided by the latter.

In the embodiment example of FIG. 8, the total height of suspension belt 20 is dimensioned as greater than its total width. Thereby, the bending stiffness of suspension belt 20 around its transverse axis is increased, which counteracts its getting stuck in the grooves of traction sheave 26 and of the idler pulleys 34a, 34b. In the example shown, the width/height ratio amounts to about 0.9.

The flank angle α of the traction ribs 80 of the first belt layer 46 is defined as the interior angle between the two flanks of a traction rib 80, and in the embodiment example amounts to about 90° (generally ranging between 60° and 120°). The correspondingly defined flank angle β of the guide rib 82 of the second belt layer 48 in this example amounts to about 80° (generally ranging between 60° and 100°).

As can be seen in FIG. 8, the flank height of guide rib 82 is bigger than the flank height of the two traction ribs 80. In that way, guide rib 82 can dive more deeply into a respective groove of the deflecting pulleys 30, 34a, 34b than the traction ribs 80 dive into the assigned grooves of traction sheave 26. Equally, it can be seen in FIG. 8 that the flank width of guide rib 82 is bigger than that of the two traction ribs 80. Due to the bigger flank width of guide rib 82, the suspension belt 20 is guided at its second exterior side 54 over a wider area in transverse direction.

As is indicated in FIG. 8, the V-ribs 80, 82 have a flattened top each, with a certain width that equals at least the minimal distance of the respective counter-flanks of the grooves of the sheaves/pulleys 26, 30, 34a, 34b. In that way, the edge embodied in these counter-flanks does not contact with the flanks of the V-ribs 80, 82, so that the latter are protected against a respective notching effect.

The first exterior surface 50 can—at least in the areas of the V-ribs 80 which contact with frictional grip with the flanks of traction sheave 26—have a coating with a PA foil, a nylon tissue, or the like. Furthermore, a V-rib 80 can optionally be given a friction-coefficient-reducing and/or noise-reducing coating.

A suspension belt 20 as described above on the basis of FIG. 8 is, for instance, explained in detail in the so far unpublished European patent application EP 06127168.0 of the applicant, which is referred to with respect to structure and form of the suspension belt 20.

The second embodiment example of a suspension belt 20, illustrated in FIG. 9, differs from the above-described example in that only one V-rib 80 is embodied instead of two V-ribs 80 at the side of the first belt layer 46. This one V-rib 80, too, has a flank angle α of about 90° (generally ranging between 60° and 120°) and a flattened top. As a result, this suspension belt 20 has V-profiles both at its first and its second exterior side 50, 54.

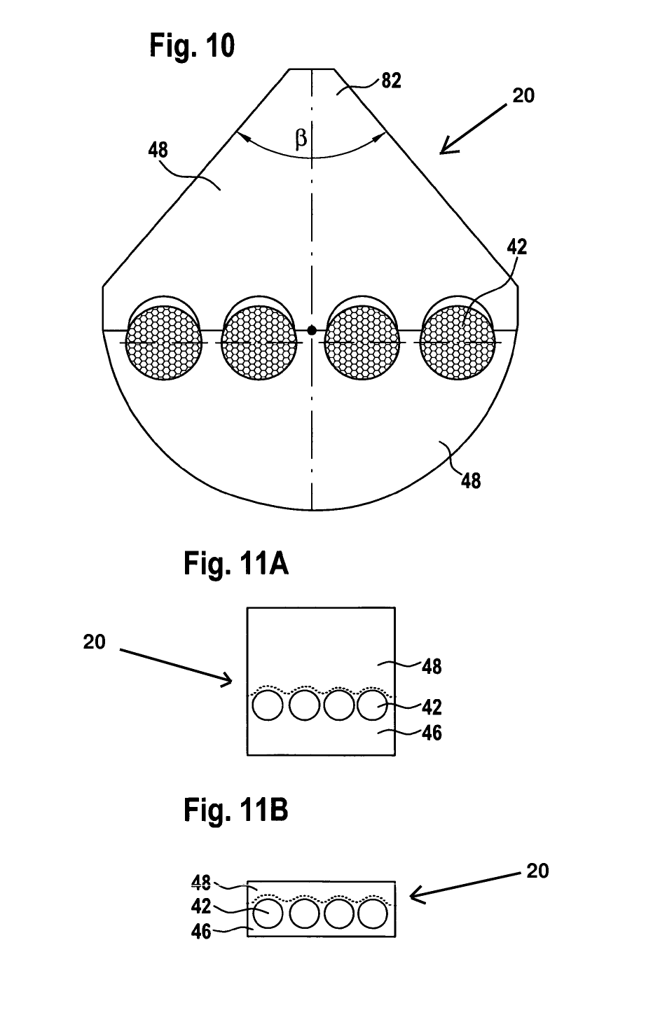

FIG. 10 shows a third embodiment example of suspension belt 20. It differs from the suspension belt 20 shown in FIG. 9 in that the V-rib 80 of the first belt layer 46 is embodied as overall rounded.

Of course, the embodiments of FIGS. 8-10 are only examples and are not meant to restrict the invention to these special shapes of suspension belt 20. Further variants of suspension elements that can be produced with the above-described manufacturing procedure of the invention are described in detail elsewhere.

While in the embodiment examples of FIGS. 8-10 the total height of suspension belt 20 was dimensioned as larger than its total width, the invention is, of course, not restricted to such a relation. As is indicated in FIGS. 11A and 11B, the present invention comprises both suspension belts 20 in which the height exceeds the width (FIG. 11A) and suspension elements 20 in which the width exceeds the height (FIG. 11B). Moreover, both rectangular and square cross-section forms are possible for suspension belt 20. Preferably, the ratio of total width to total height of the (non-round, sheathed) suspension belt 20 ranges from 0.8 to 1.2, in particular from 0.9 to 1.1.

The embodiment example of a suspension belt 20 illustrated in FIG. 6S differs from the above-described examples in that only one V-rib 80 is embodied at the side of the first exterior belt layer 46 instead of two V-ribs 80. This one V-rib 80, too, has a flank angle α of about 90° (generally ranging from 60° to 120°) and a flattened top. On the whole, this suspension belt 20 has a V-profile both at its first and at its second exterior surface 50, 54.

FIG. 7S shows an embodiment example of suspension belt 20 the V-rib 80 of the first belt layer of which has an overall rounded (dashed line 51) or at least partly rounded shape (uninterrupted line 51).

In the embodiment example given above, the manufacturing of a suspension belt 20 with a certain width and a certain number of embedded tension members 42 and V-ribs 80, 82 was described. In particular in the case of narrow suspension belts 20 (i.e., height/width >1), as they are exemplarily shown in FIGS. 8-10, however, it is also possible in the context of the invention to produce several such suspension belts 20 simultaneously, placed side by side, and/or in one piece.

With this variant, it is possible to produce at first a broad suspension belt (primary product) with a great number of tension members 42, and subsequently separate it into several individual suspension belts 20 of smaller width. To this end, various mechanical procedures, like cutting, sawing, etc., may be applied. To facilitate the separation process, respective predetermined breaking lines and/or perforations can be conceived in the primary product comprising several suspension belts 20. Furthermore, for severing the individual narrow suspension belts 20, a traction sheave 26 can be conceived in which individual grooves have a greater distance of each other than two ribs to be made engage with them of two neighbouring suspension belts to be separated, so that the primary product is spread apart at these sites and eventually is severed in the elevator system into several narrow suspension belts 20.

For simpler handling, the broad suspension belt 20 can be equipped with a support band or mounting band, e.g. of plastic, or with foil-type clamps, or the like, which may remain in place even after the severing process and are possibly removed only in the mounting of suspension belt 20 in an elevator system. This procedure is, for instance, explained in detail in the European patent application EP 06118824.9 of the applicant, which is referred to in this respect.

According to another aspect of the invention, a belt-type suspension element for an elevator system is conceived (in the following simply denoted as “suspension belt” or “belt”), which is described below.

In a preferred embodiment of a suspension element according to invention, a multitude of rope-type tension members are arranged in one or more common sheathing(s), where a sheathing—in particular an external sheathing—has a non-round cross-section. An external sheathing preferably constitutes a shape-determining and/or function-determining moulded body of the suspension element. Number and arrangement of the tension members in the moulded body are preferably chosen such that a compensation of different torques or torsional moments is realized in the suspension element. Optionally, individual tension members are assigned individual sheathings, which are sectionally or completely embedded in the moulded body. The moulded body preferably has a triangular, square, pentagonal, hexagonal, or polygonal cross-section, which basically remains constant over the whole length of the suspension element. The moulded body may, however, have a preferably regular toothing along its longitudinal extension, which assigns the moulded body at least two different cross-section shapes alternating along the longitudinal extension of the suspension element.

The moulded body of the suspension element has at least one traction side, via which the suspension element can be brought into contact with a so-called traction sheave or drive shaft, as this is described in detail elsewhere in this document. Furthermore, the moulded body preferably has a guide side, looking away from the traction side, via which the suspension element can particularly be made engage with guide pulleys and/or deflecting pulleys. In a modified embodiment example, the moulded body of the suspension element has two traction sides (particularly located opposite each other), which can be made engage with a traction sheave or drive shaft each.

In one embodiment, the moulded body (seen in cross-section to its longitudinal axis) has at least two areas or layers with different properties: a first area interacting during operation with the traction sheave (also called traction side), and an area opposite to the latter, which either serves to protect the tension members against environmental influences or to guide and/or deflect (guide side). Between these areas, a base body can be conceived as another area (arranged centrally between traction side and guide side). A tension member can be arranged completely or partly in one of these areas. Preferably, all tension members are arranged in the base body or in the area of the guide side. In one embodiment, one or more so-called “irrotational” ropes on steel basis or synthetic-fibre basis are embedded in the base body as tension members. As a steel rope, for instance an irrotational steel rope in accordance with DIN 3071 is conceived.

In another embodiment, at least two tension members are conceived, the torques or torsional moments of which counterbalance each other in such a manner that the whole suspension element is almost irrotational and/or torque-free.

In another embodiment, the suspension element has at least one tension member and on its traction side at least one V-rib, with the at least one tension member being centrically or force-symmetrically assigned to the V-rib. In a modified embodiment example, the suspension element has at least two times two tension members, which are centrically and/or symmetrically assigned to at least two V-ribs side-of-traction, and centrically and/or symmetrically to at least one V-rib side-of-guide.

A modification of the suspension element conceives a one-layer moulded body with one or more embedded tension members, with the suspension element comprising at least one respective rib extending in longitudinal direction of the suspension element and/or at least one groove extending in longitudinal direction of the suspension element, preferably at two (preferably in particular opposite) sides of the moulded body. In another modification, the belt-type suspension element has at least one moulded body, constituted by two belt layers, with one or more embedded tension members.

In a preferred embodiment, a belt-type suspension element according to invention for an elevator system has a first belt layer made of a first plasticizable material, with a first exterior surface, and a surface constituting a connection plane, as well as at least one rope-type tension member, which is embedded in the first belt layer such that it partly protrudes from the connection plane of the first belt layer, and the protruding section of the at least one tension member is at least partly covered by the first plasticizable material. Furthermore, the belt-type suspension element comprises a second belt layer, made of a second plasticizable material, which is moulded to the connection plane of the first belt layer and the protruding sections of the at least one tension member, and forms a second exterior surface of the suspension element.

The first belt layer and the second belt layer of the suspension belt can be made optionally of a material of the same material group (e.g. the group of thermoplastic elastomers), of the same material (e.g. an EPDM with identical composition), of a similar material with different properties (e.g. a thermoplastic polyurethane, and the same thermoplastic polyurethane with a plasticizer as additive), or of different materials, in particular very different plastics (e.g. a thermoplastic elastomer, and a vulcanizable synthetic rubber, or a tissue, in particular an impregnated tissue).

In one embodiment of the invention, the first exterior surface of the first belt layer is embodied with at least one first rib extending in longitudinal direction of the suspension element, which preferably has the form of a V-rib with a flank angle ranging between 50° and 130° and/or has a flattened top.

In another embodiment of the invention, the second exterior surface of the second belt layer is embodied with a second rib extending in longitudinal direction of the suspension element, which preferably has the form of a V-rib with a flank angle ranging between 50° and 120° and/or has a flattened top. Embodiments with a first V-rib on the first exterior surface, or with only a second V-rib on the second exterior surface, or with V-ribs on first and second exterior surface, opposite or alternately opposite each other, are conceivable.

In still another embodiment of the invention, the ratio of the total height of the suspension element to its total width is greater than 1, with the height extension being aligned as basically perpendicular to a (possibly imaginarily cylindrical) traction surface of an assigned traction sheave. Alternatively, this ratio may, however, also amount to approximately 1 or be smaller than 1.

FIG. 3 schematically shows the basic structure of a two-layer belt-type suspension element 20 for an elevator system. As can be seen, the suspension element 20 comprises a belt body 44, also called moulded body 44, with a first belt layer 46 made of a first plasticizable material, and a second belt layer 48 made of a second plasticizable material. The belt body 44 has a first exterior surface 50 at the side of the first belt layer 46. Between the first and the second belt layer 46, 48, there is a connection plane 52. Furthermore, the belt body 44 has a second exterior surface 54 of the second belt layer 48, at its side opposing the first exterior surface 50. In the area of the connection plane 52, several rope-type tension members 42 are embedded in the two-layer belt body 44.

In the context of the present invention, in particular ropes, strands, cords, or braidings of metal wires, steel, synthetic fibres, mineral fibres, glass fibres, carbon fibres, and/or ceramic fibres can be used as rope-type tension members 42 (as was mentioned before). The rope-type tension members 42 can be formed of one or more single elements or of singly or multiply stranded elements.

In one embodiment of the invention, each tension member 42 comprises a two-layer core strand with a core wire (e.g. of 0.19 mm diameter) and two wire layers (e.g. of 0.17 mm diameter) laid around it, as well as one-layer outer strands with a core wire (e.g. 0.17 mm diameter) arranged around the core strand, and a wire layer (e.g. 0. of 155 mm diameter) laid around it. Such a tension member structure, which, for instance, may comprise a core strand with 1+6+12 steel wires and eight outer strands with 1+6 steel wires, has proved in tests as advantageous regarding strength, manufacturability, and bendability. Favourably, here, the two wire layers of the core strand have the same angle of lay, while the one wire layer of the outer strands is laid in the sense opposing the direction of lay of the core strand, and the outer strands are laid in the sense opposing the direction of lay of their own wire layer around the core strand. But, of course, the present invention is not restricted to tension members 42 with this special tension member structure.

The use of rope-type tension members 42 (partly also called cords) with small diameters (or thickness) transverse to the longitudinal extension of the suspension element 20 allows the use of traction sheaves 26 and idler pulleys 30, 34a, 34b with small diameters. The diameter of the tension members 42 preferably ranges from 1.5 mm to 4 mm.

In the embodiment of suspension belt 20 shown in FIG. 3, the first exterior surface 50 (traction side) of the first belt layer 46 of belt body 44 engages during operation with the traction surface of traction sheave 26, while the second exterior surface 54 (guide side) of the second belt layer 48 for instance engages with the riding surfaces of the counterweight idler pulley 30 and the two car idler pulleys 34a, 34b. But of course, the suspension element 20 of the invention can also be used in the reverse mode in an elevator system with traction drive, as is depicted in FIGS. 2A and 2B. That is, the first exterior surface 50 of the first belt layer 46 of belt body 44 may as well engage with the traction surface of traction sheave 26, while the second exterior surface 54 of the second belt layer 48 engages with the riding surfaces of the counterweight idler pulley 30 and the two car idler pulleys 34a, 34b.

The first material for the first belt layer 46 and the second material for the second belt layer 48 can be the same material, the same material with different properties, materials of the same material class, or else different materials, in particular different synthetic materials. For instance elastomers like the following are eligible as materials for the belt layers 46, 48: polyurethane (PU), polyamide (PA), polyethylene terephthalat (PET), polypropylene (PP), polybutylene terephthalat (PBT), polyethylene (PE), polychloroprene (PCP), polyethersulphone (PES), polyphenylsulfide (PPS), polytetrafluoroethylene (PTFE), polyvinyl chloride (PVC), ethylene propylene diene monomer rubber (EPDM). The list of the mentioned materials is non-conclusive, and the selection of a material for the belt layers 46, 48 as well as for the formation of the moulded body 44 of suspension element 20 is not restricted to the listed materials. In addition, special adhesion mediators can be added to the materials for the first and the second belt layer 46, 48, so as to increase the strength of the connection between the belt layers 46, 48 and between the belt layers 46, 48 and the tension members 42. Equally, the incorporation of further tissues, and/or tissue fibres, and/or carbon, glass, or polyamide fibres, in particular aramid fibres, and/or finely dispersed particles of metals and/or metal oxides, or other filling materials is possible. Further materials, combinations of materials, and admixtures that are advantageous and usable or combinable according to invention are described elsewhere in this document, as are further geometries and application fields of the suspension elements according to invention or of their moulded bodies.

To optimize the required properties, like friction coefficient, transverse stability, quiet running, noise reduction, and torsion stiffness, also coatings on the first and/or the second exterior surface 50, 54 can be conceived (not depicted here, complementarily described elsewhere). They may, for instance, be tissues of metal and/or synthetic and/or natural fibres, and/or thin layers of plastic, and/or composite materials with metal and/or synthetic and/or natural fibres, and or with finely dispersed particles of metals and/or metal oxides. Such coatings can also be conceived as sacrificial layers regarding wear.

In a possible manufacturing procedure, the first and the second belt layer are formed in an extrusion procedure each. Basically, a vulcanizable thermoplastic elastomeric material can be employed here as well, e.g. EPDM, in which case, of course, the vulcanization can only take place after the extrusion procedure, and preferably after the production of an at least approximate definite form.

According to invention, it is possible to use, for the first belt layer 46 and the second belt layer 48, respectively, the same material with the same properties, the same material with different properties, or different materials. The properties of the material(s) of relevance for the moulded body 44 include in particular hardness, flowability, compression, properties of connection with the rope-type tension members 42 and/or the second material of the other belt layer, reverse bending strength, tensile strength, compressive strength, wear properties, colour, and the like.

In special embodiments of the invention, at least one of the belt layers 46, 48 can be made of a transparent material, so as to facilitate a check of the suspension element 20 for damages. Besides, the first and/or second belt layer can be embodied in anti-static quality. In another embodiment, the second belt layer can, for instance, be embodied as luminescent, so as to make the rotation of the traction sheave or the drum recognizable, or to achieve certain optic effects.

In accordance with the provisions of the patent statutes, the present invention has been described in what is considered to represent its preferred embodiment. However, it should be noted that the invention can be practiced otherwise than as specifically illustrated and described without departing from its spirit or scope.

1. A sheathed and/or belt suspension element for an elevator system, comprising:
a first layer of the suspension element made of a first plasticizable and/or elastomeric material and having a first exterior surface;
a second layer of the suspension element, said first and second layers each being formed of one of polyurethane (PU), polyamide (PA), polyethylene terephthalat (PET), polypropylene (PP), polybutylene terephthalat (PBT), polyethylene (PE), polychloroprene (PCP), polyethersulphone (PES), polyphenylsulfide (PPS), polytetrafluoroethylene (PTFE), polyvinyl chloride (PVC), and ethylene propylene diene monomer rubber (EPDM) materials;
a connection plane formed between the first and second layers; and
at least one tension member embedded in an area of the connection plane, a majority of a surface of said at least one tension member directly contacting said first layer, wherein said tension member is formed as a rope, a fabric, or a plurality of sub-elements.

2. The suspension element according to claim 1 wherein said first exterior surface of the suspension element has at least one rib extending in a longitudinal direction of the suspension element with at least one of a flank angle ranging from 60° to 120° and a flattened cone point.

3. The suspension element according to claim 1 wherein a second exterior surface of the suspension element has at least another rib extending in the longitudinal direction of the suspension element with at least one of a flank angle ranging from 60° to 100° and a flattened cone point.

4. The suspension element according to claim 1 wherein a ratio of a height of the suspension element to a width of the suspension element is greater than 1.

5. The suspension element according to claim 1 wherein a ratio of a height of the suspension element to a width of the suspension element is approximately 1 and a cross-section of the suspension element is non-round.

6. The suspension element according to claim 1 wherein a belt body of the suspension element has a first belt layer as said first layer and a second belt layer, wherein said first belt layer has a plurality of traction ribs that directly engage with assigned grooves of a traction sheave, and wherein said second belt layer has a guide rib that directly engages with an assigned pulley.

7. The suspension element according to claim 1 wherein the first layer includes a base body having a first traction surface arranged opposite a second traction surface, wherein said first traction surface is configured to engage with a first pulley or sheave and said second traction surface is configured to engage with a second pulley or sheave.

8. The suspension element according to claim 7 wherein said second traction surface has a non-linear transverse contour aligned transversely to a longitudinal direction of a force transmission element in said base body.

9. The suspension element according to claim 8 wherein said transverse contour of said second traction surface is identical with a transverse contour of said first traction surface.

10. The suspension element according to claim 7 wherein at least one of said first traction surface and said second traction surface is configured to have at least one of a friction coefficient, hardness, and abrasion resistance that differs from a respective value of said base body.

11. The suspension element according to claim 7 wherein said at least one tension member is a force transmission element attached in a form-locking manner to said first layer whereby said base body at least partially encloses said force transmission element, and wherein said base body has at least one subdivided layer, which layer is subdivided into individual spaced apart sections each in parallel to a longitudinal extension of said at least one force transmission element.

12. The suspension element according to claim 7 wherein said base body has at least one layer that extends over at least one of a whole width of said base body and a whole length of said base body.

13. The suspension element according to claim 7 wherein a subdivided layer of the base body is divided into individual spaced apart sections and is connected with a layer that extends over a width of said base body.

14. The suspension element according to claim 7 wherein said at least one tension member comprises a first material being adhesively bonded to or identical with a material of which at least one layer of said base body is made.

15. The suspension element according to claim 7 wherein a force transmission element includes a sheathing of a second material being different from and adhesively bonded to, or identical with and separate from, a material of which at least one layer of said base body is made.

16. The suspension element according to claim 1 wherein said at least one tension member is embedded in a synthetic carrier, and wherein said at least one tension member is formed of aramid fibers.

17. The suspension element according to claim 1 wherein said first exterior surface of the suspension element has at least two adjacent ribs extending in a longitudinal direction of the suspension element with a flank angle between said ribs ranging from 80° to 100°.

18. A belt suspension element for an elevator system, comprising:
a base body having a first traction surface arranged opposite a second traction surface, wherein said first traction surface directly engages with a first pulley or sheave and said second traction surface directly engages with a second pulley or sheave, said base body being formed of a plasticizable and/or elastomeric material; and
at least one force transmission element formed as a rope, a fabric, or a plurality of sub-elements, wherein said at least one force transmission element is attached to said base body in a form-locking manner whereby said base body at least partially encloses said at least one force transmission element, a majority of a surface of said at least force transmission element directly contacting said base body, and wherein said base body has at least one subdivided layer, which layer is subdivided into individual spaced apart sections in parallel to a longitudinal extension of said at least one force transmission element.
